(19) United States
(12) Patent Application Publication
(10) Pub. No.: US 2013/0332396 A1
(43) Pub. Date: Dec. 12, 2013

(54) MANIPULATION OF MULTI-DIMENSIONAL PRICING STRUCTURES

(71) Applicant: Brian Welcker, Seattle, WA (US)

(72) Inventor: Brian Welcker, Seattle, WA (US)

(73) Assignee: Microsoft Corporation, Redmond, WA (US)

(21) Appl. No.: 13/494,038

(22) Filed: Jun. 12, 2012

(51) Int. Cl. G06Q 30/00

(52) U.S. Cl. 705/400

(57) ABSTRACT

A pricing component generates a user interface that allows a user to select dimensions that are to be considered in generating pricing information. The dimensions can be set in a precedence hierarchy so the user can identify which dimensions are used, and the order of evaluation of a price according to those dimensions. Once the user wishes to begin setting the pricing according to the selected dimensions, the pricing component generates another user interface display in order to allow the user to begin setting the prices for combinations of specified dimension values.

### BACKGROUND

It is common for people to consider multiple different dimensions or attributes when making quantitative decisions. Automating this process requires the user to populate a data structure with the different dimension values to be considered in order to arrive at a result. However, this type of data structure is often presented in a fixed tabular fashion with the combination of dimension values listed as a set of rows in the table. This makes it difficult for a user to understand the results of dimension combinations.

One common environment where multiple dimensions are considered is in a business data system where a user is attempting to establish the price for goods or services. Different companies use different ways to establish prices. Some prices may be specific to the goods or services being offered. Other prices may be specific to a contract that the company has with a customer. Other prices may be specific to the individual that is performing the services under a given contract. Still other prices may be related to the volume of goods or services purchased, to promotional programs being run, or to the time of year that the goods or services are purchased. Of course, there are a wide variety of other attributes or dimensions that can be considered by a company in setting the price for its goods and services.

Given all of these considerations, it can be difficult for a company to specify how to set the price of its goods and services, for example, in specifying the precedence of certain attributes over others. Further, it can be difficult, in looking back after the prices were set, to determine exactly why the prices were set the way they were. By way of example, assume that a company set a price for a combination of customer, currency and product (which superseded the general product price) at a specific level three years ago, but is now renegotiating its agreement with that given customer. It can be difficult, if not impossible, to determine exactly why the price was set the way it was three years earlier.

The problem of establishing prices, and figuring out why prices were set the way they were in the past, is exacerbated because companies often update and change their pricing structure. The problem also becomes worse as the number of dimensions or attributes that a company desires to consider in setting its price increases. The problem is also exacerbated where the company offers a wide variety of different goods and services, and where those goods and services are offered to a wide variety of different customers in a wide variety of different geographic areas.

The discussion above is merely provided for general background information and is not intended to be used as an aid in determining the scope of the claimed subject matter.

### SUMMARY

A pricing component generates a user interface that allows a user to select dimensions that are to be considered in generating pricing information. The dimensions can be set in a precedence hierarchy so the user can identify which dimensions are used, and the order of evaluation of a price according to those dimensions. Once the user wishes to begin setting the pricing according to the selected dimensions, the pricing component generates another user interface display in order to allow the user to begin setting the prices for combinations of specified dimension values.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative data system.

FIG. 2 is a flow diagram illustrating one embodiment of the operation of the system shown in FIG. 1 in generating a multi-dimensional pricing structure.

FIGS. 3A-3I are exemplary user interface displays generated by the system shown in FIG. 1.

FIG. 4 is a block diagram showing various architectures in which the system of FIG. 1 can be deployed.

FIGS. 5-9 show a plurality of different mobile devices.

FIG. 10 shows one illustrative computing environment.

### DETAILED DESCRIPTION

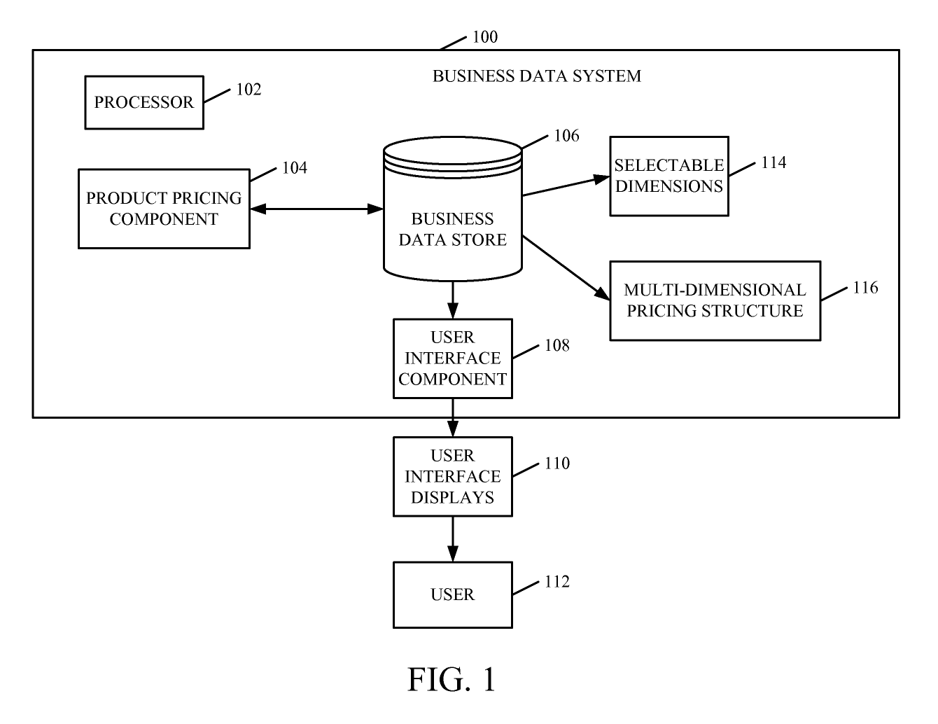

FIG. 1 is a simplified block diagram of an illustrative business data system 100. System 100 includes processor 102, product pricing component 104, business data store 106 and user interface component 108. User interface component 108 illustratively generates user interface displays 110 that include user input mechanisms that are actuatable by user 112 to provide inputs to configure and control business data system 100. In the embodiment shown in FIG. 1, business data store 106 illustratively includes business data, such as selectable dimensions 114 and multi-dimensional pricing structure 116.

In one embodiment, business data system 100 is an enterprise resource planning (ERP) system or a customer resource management (CRM) system or any other suitable business data system. Product pricing component 104 is illustratively used by user 112 to set pricing for products or services offered by a company or other organization that employs business data system 100.

It will of course be appreciated that product pricing component 104 can be used for setting the pricing of products or services, or both. It is simply referred to as product pricing component 104 for the sake of brevity.

In one embodiment, processor 102 is illustratively a computer processor with associated memory and timing circuitry (not shown). Processor 102 is illustratively a functional component of system 100 and facilitates the operation and functionality of other components or portions of system 100.

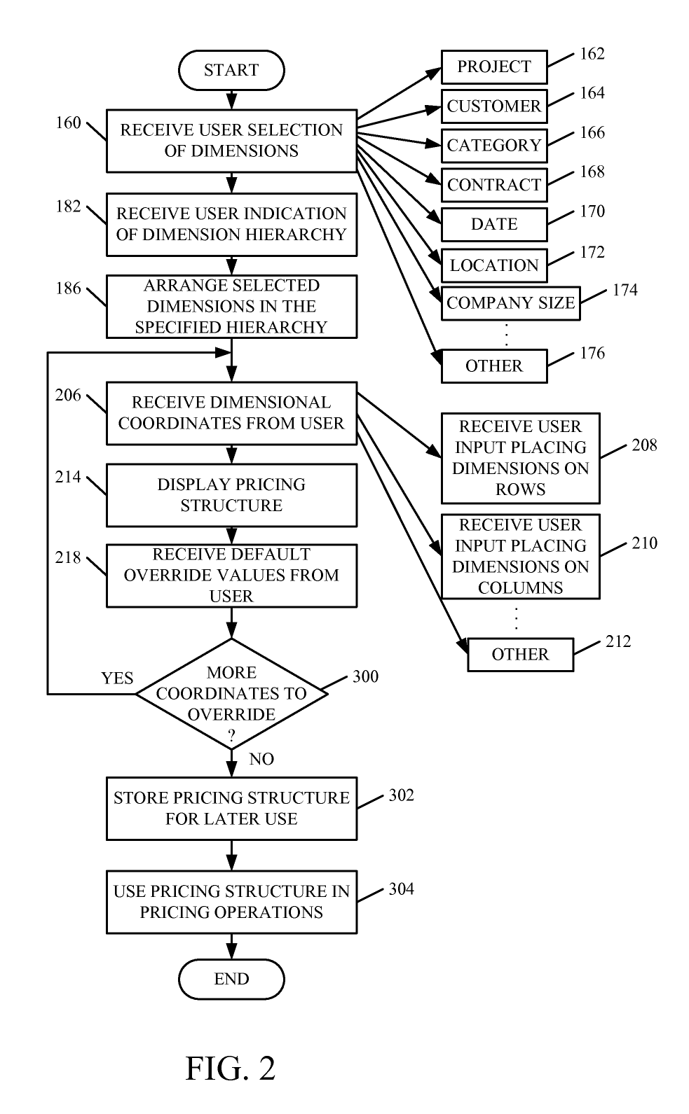

The operation of system 100 is described in greater detail below with respect to FIG. 2. Briefly, however, user 112 interacts with system 100 through user interface displays 110 in order to select a plurality of different dimensions 114 that are to be considered in setting the price of goods or services. User 112 selects those dimensions 114 to configure a multi-dimensional pricing structure 116 that can be used to generate pricing for goods and services based upon the selected dimensions. Product pricing component 104 generates the user interface displays 110 using user interface component 108 so that user 112 can select dimensions 114 to configure multi-dimensional pricing structure 116, and store it in business data store 106 for later use. When the user is attempting to set a price for a product or service, user 112 accesses the multi-dimensional pricing structure 116. Similarly, when the user is attempting to determine why a given price was quoted or agreed to for a given customer in the past, user 112 can also access multi-dimensional pricing structure 116 to identify the particular dimensions that were considered, the date range, promotions that were in place at the time, etc. In any case, user 112 can use the multi-dimensional pricing structure 116 not only to set prices for future offerings of products or services, but to identify what prices were charged in the past, and the particular dimensions that were considered in setting those prices.

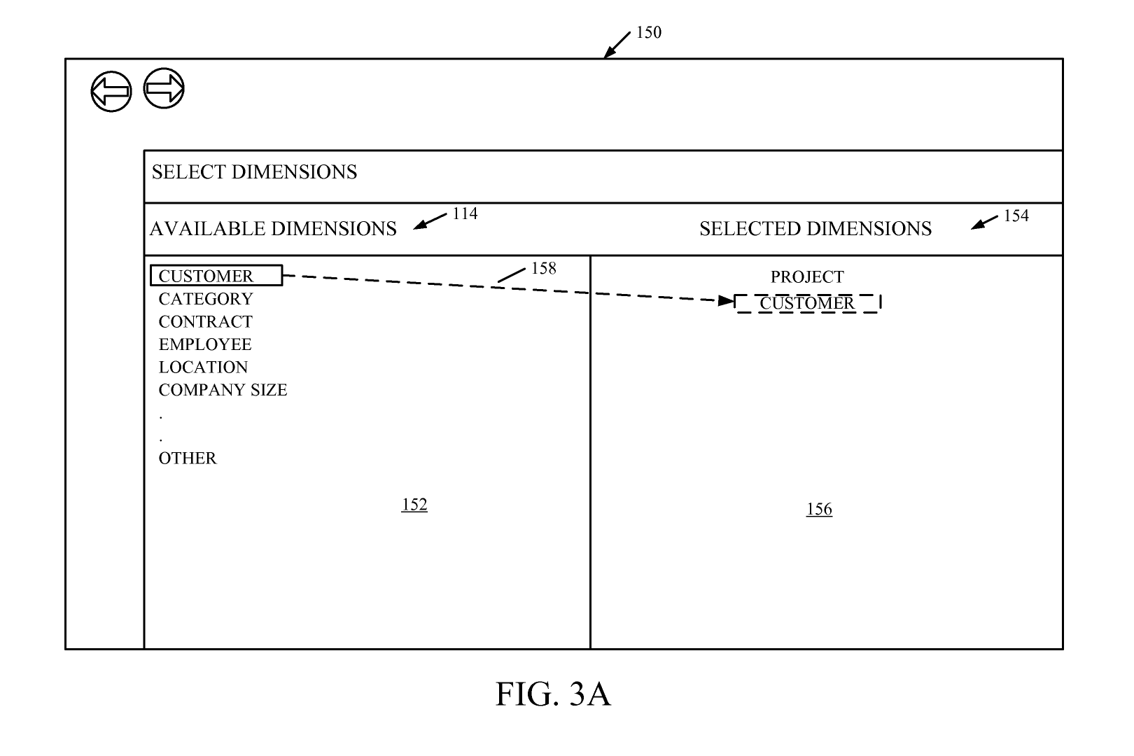

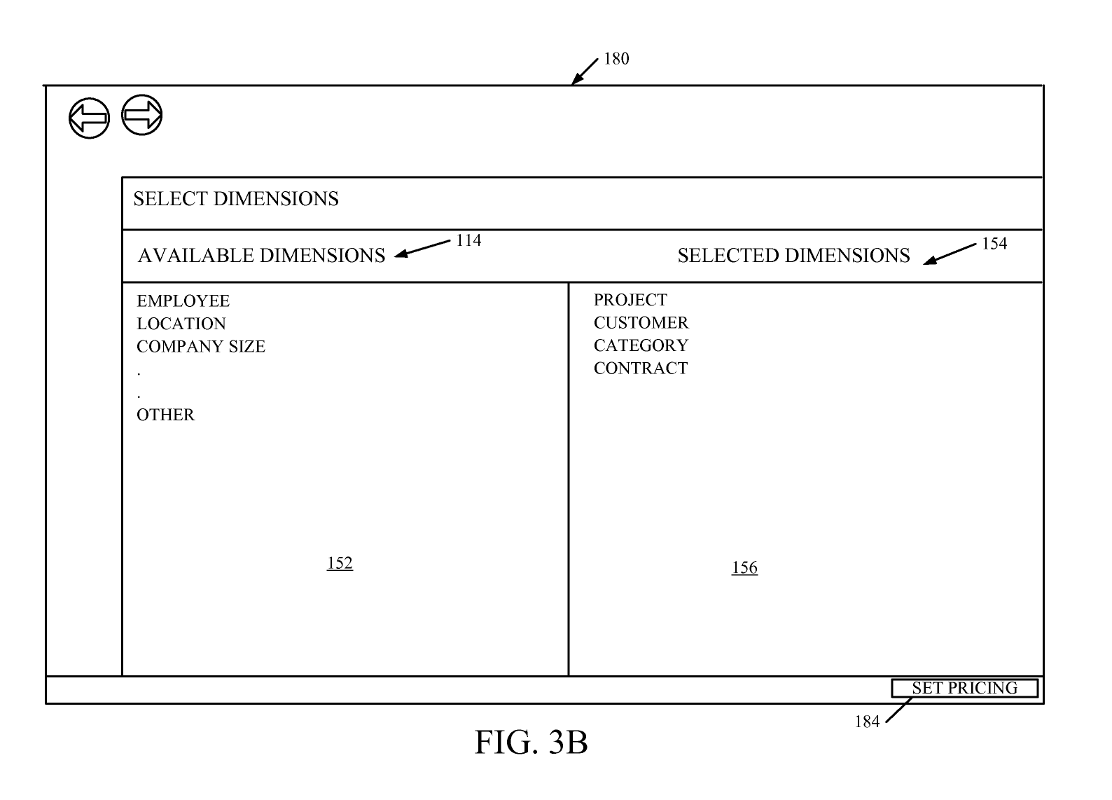

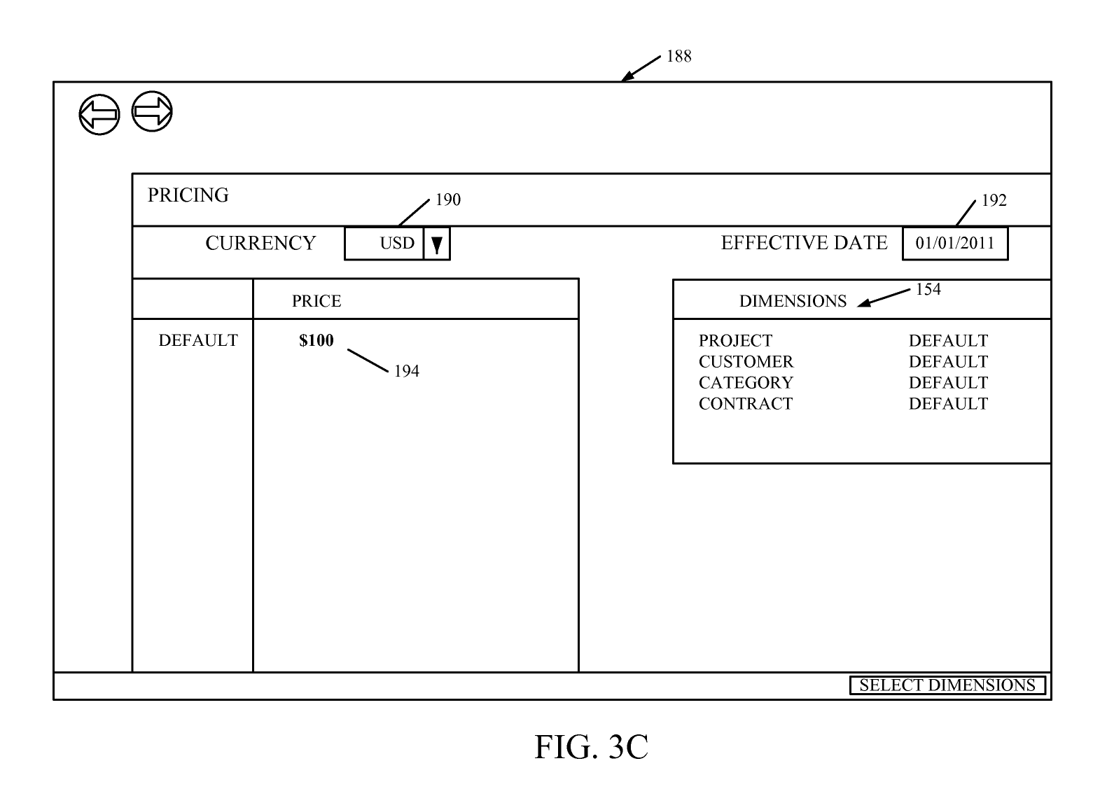

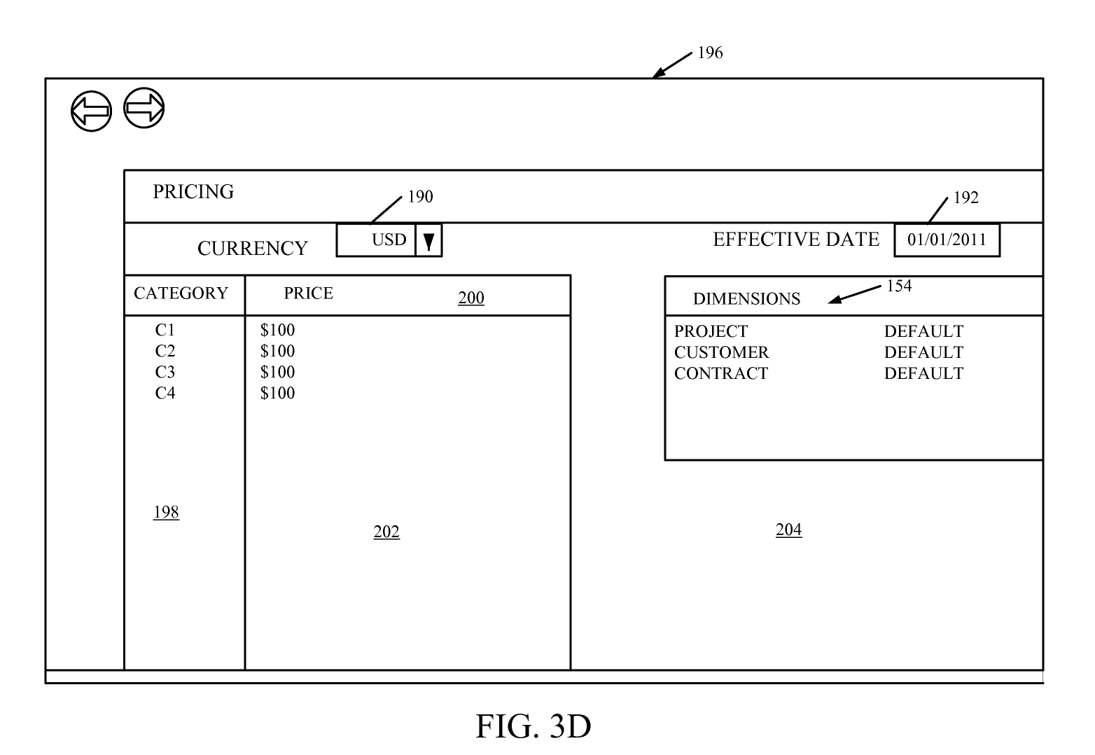

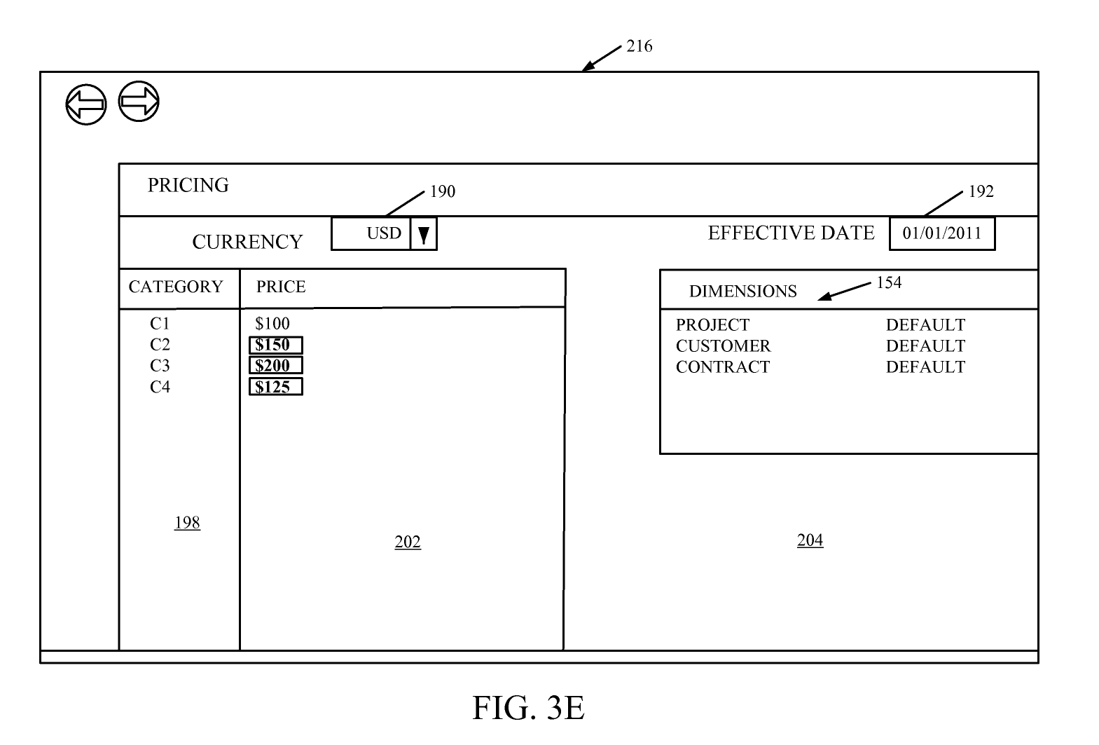

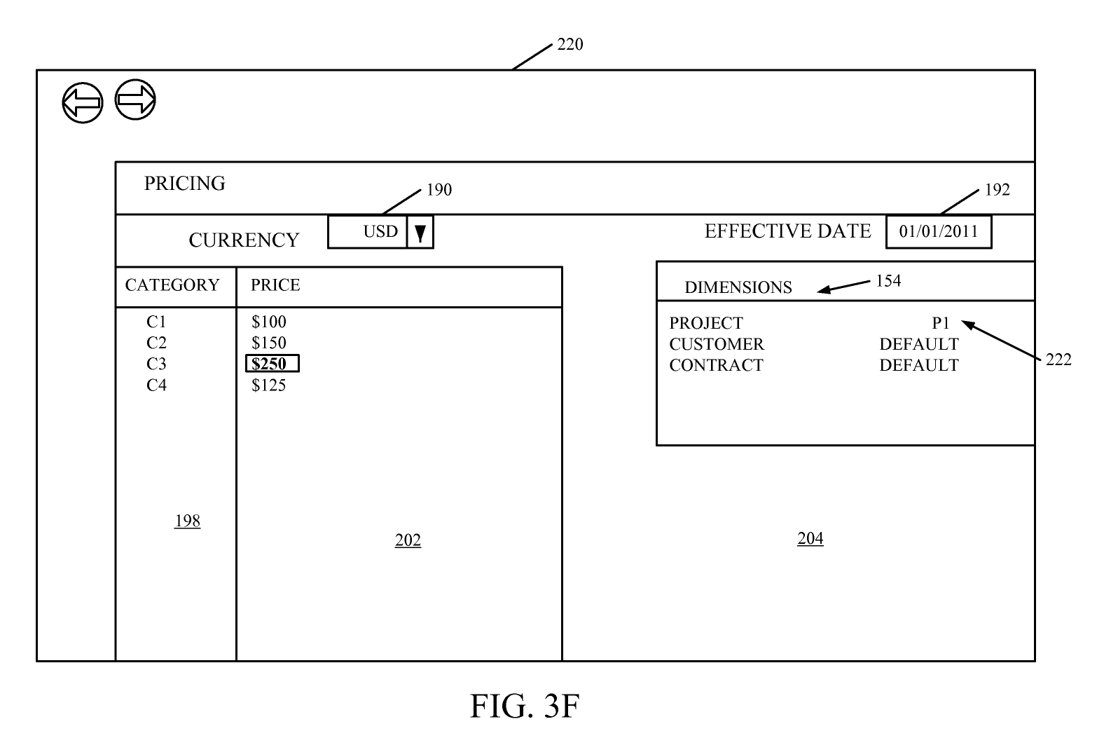

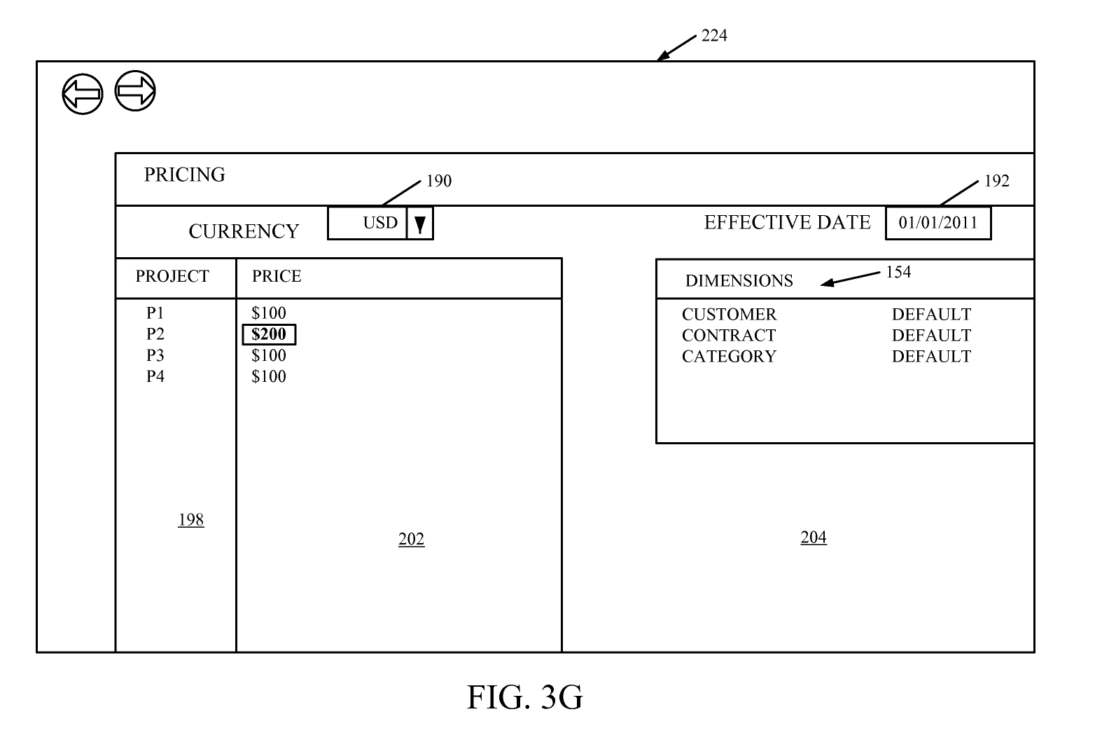

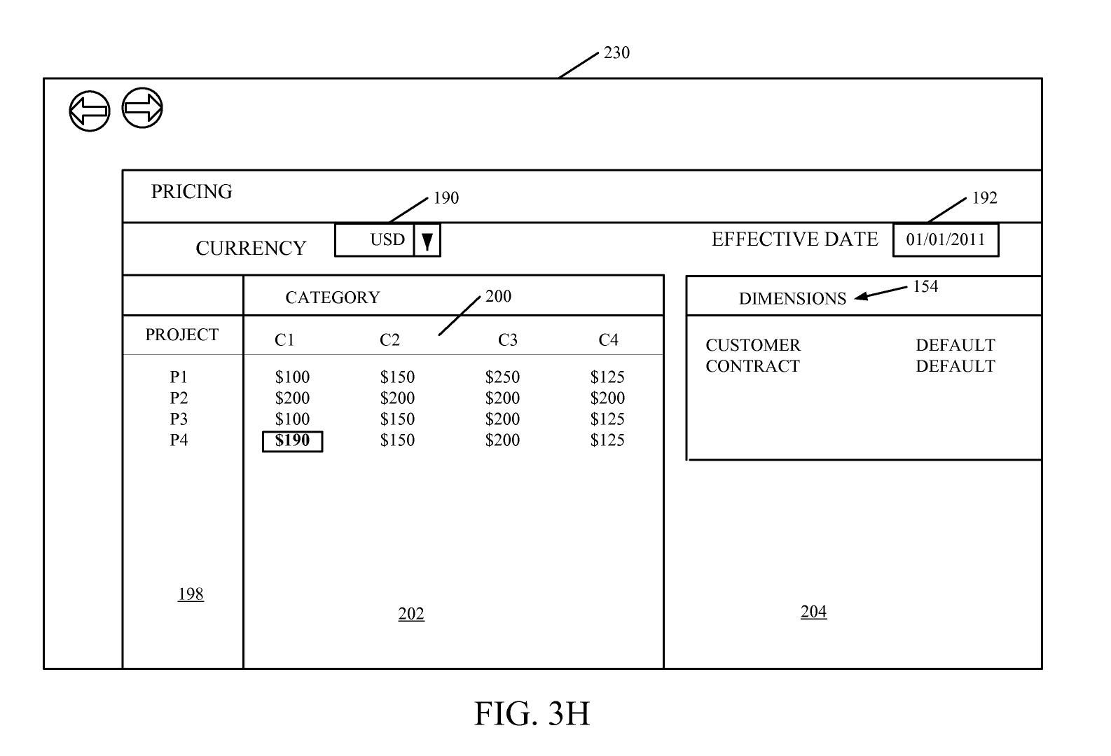

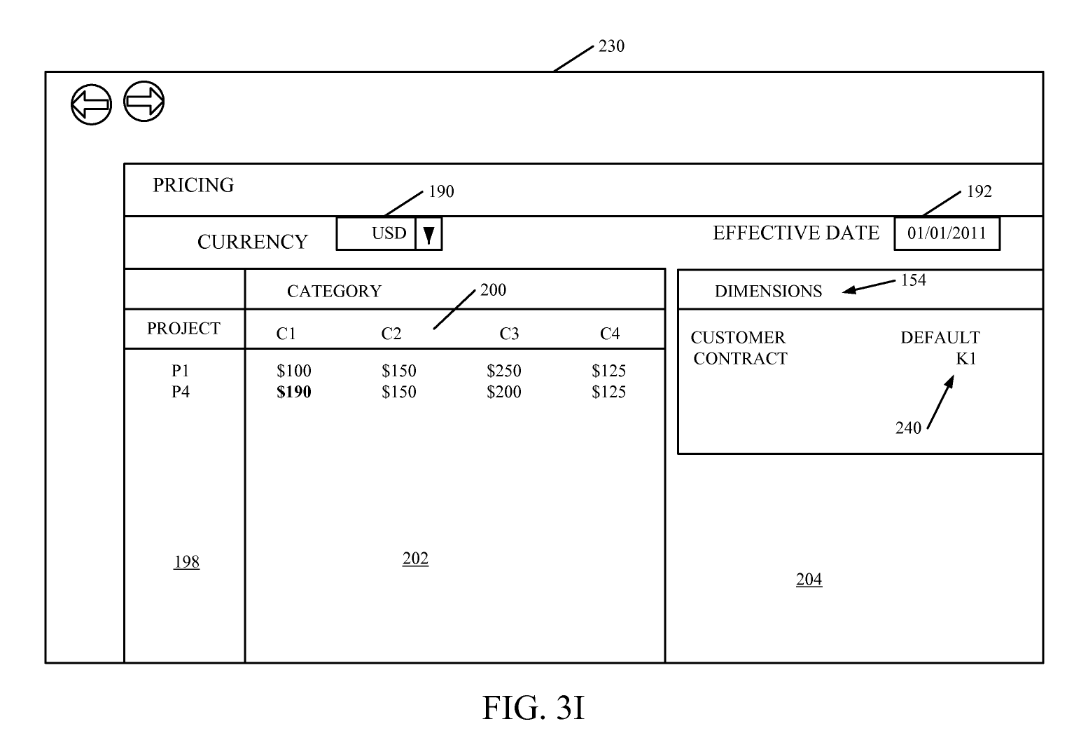

FIG. 2 is a flow diagram illustrating the operation of system 100 in more detail. FIG. 2 shows one embodiment of the overall operation of system 100 in enabling user 112 to select dimensions 114 to configure a multi-dimensional pricing structure 116 so that it can be used for determining the prices of products or services. FIGS. 3A-3I show examples of user interface displays 110 that can be generated by product pricing component 104 using user interface component 108 during operation of system 100. FIGS. 2-31 will now be described in conjunction with one another.

In order to generate multi-dimensional pricing structure 116 for use in pricing, user 112 first provides an input to business data system 100 indicating to product pricing component 104 that the user 112 wishes to do this. In response, product pricing component 104 illustratively generates a user interface display, using user interface component 108, that allows user 112 to select dimensions 114 for use in generating a multi-dimensional pricing structure 116. One embodiment of such a user interface display is display 150 shown in FIG. 3A.

Display 150 includes a set of selectable dimensions 114 on one pane 152 and also includes a set of selected dimensions 154 that are displayed on pane 156. In the embodiment shown in FIG. 3A, product pricing component 104 receives user inputs selecting dimensions 114 and identifying them as selected dimensions 154. In the specific embodiment shown in display 150, the user selects dimensions by simply dragging dimensions from pane 152 onto pane 156. Selected dimensions 154 are those which will be used in multi-dimensional pricing structure 116 being created by user 112. Dragging and dropping a dimension from pane 152 to pane 156 is indicated by dashed arrow 158 in FIG. 3A. Receiving user selection of dimensions 114 is indicated by block 160 in FIG. 2.

It will be appreciated that a wide variety of dimensions 114 can be selected by the user. Some of those include a project dimension 162 that identifies a specific project for which pricing is being determined. Another is a customer dimension 164 that identifies a customer, and other dimensions include category dimensions 166 that identify categories of products or services. For instance, if the multi-dimensional pricing structure 116 is being generated by a company that performs services on a fleet of vehicles for a customer, then the category dimensions 166 might include “tires”, “wiper blades”, “tune-ups”, or other products or services in different categories.

The dimensions 114 can also include a contract dimension 168 that identifies a specific contract with a customer. The dimensions can include a location dimension 172 that identifies a geographic location of the customer for which the pricing is being determined, and a company size dimension 174 that identifies the size of the company for which the pricing is being determined. By way of example, user 112 may desire to price products or services differently for larger companies located in a specific geographic region (such as on the west coast) than it does for smaller companies in that same geographic region, or for companies in a different geographic region. All of these dimensions can be selected by the user 112. Although not individually selectable, the pricing table will also include a date dimension 170 that identifies the effective date of the pricing. Of course, those dimensions shown in FIGS. 2 and 3A are exemplary only and other dimensions can be used as well, and this is indicated by block 176 in FIG. 2.

It will also be noted that other types of user input mechanisms, other that dragging and dropping, can be used to select dimensions 114. For instance, they can be selected from a dropdown menu, using check boxes, or using any other desired type of user input mechanism. Similarly, user input mechanisms can include voice commands, touch gestures, inputs from point and click devices or keyboards, or any other type of mechanism as well.

It should also be noted that, in one embodiment, selected dimensions 154 can be ordered on pane 156 according to a hierarchical structure. That is, it may be that the user wishes to have the pricing established for a given project always override the pricing established under a given contract. By way of example, assume that the company for which user 112 is working has an overall contract with a specific customer to perform maintenance services on different fleets of vehicles. However, assume that the overall contract includes a number of different projects. For instance, the company may be performing maintenance on a fleet of taxi cabs as a first project, but may be performing maintenance services on a fleet of diesel engine busses as a second project. It may be that the company needs to pay its diesel mechanics higher wages than its conventional auto mechanics. In that case, the company may set the pricing structure for the second project (maintaining the diesel engine busses) higher than the first project (maintaining the gasoline engine taxi cabs). Therefore, while user 112 may set up an overall price to be charged under the overall contract, user 112 does want the project specific pricing (whenever it is used) to override the overall contract pricing. In order to accommodate this, product pricing component 104 allows the user to place the selected dimensions in pane 156 in a hierarchical order that establishes the priority in which each of the dimensions pricing will be evaluated.

FIG. 3 shows one example of this in user interface display 180. It can be seen in FIG. 3B that the user has selected, as selected dimensions 154, the dimensions project, customer, category and contract. The user has also identified four categories under the category dimension, and labeled them C1, C2, C3, and C4. Because the user has ordered the dimensions in pane 156 in a specific order, this establishes the hierarchical priority among those dimensions. The higher priority dimensions are placed higher in the hierarchy shown in pane 156. Therefore, a category pricing structure will always take precedence over a contract pricing structure, when the two are in conflict. Similarly, a project pricing structure will always take precedence over a customer pricing structure, a category pricing structure and a contract pricing structure. That is, the dimensions located higher up in the hierarchy shown in pane 156 take precedence over those located lower in the hierarchy, when two or more of them are in conflict. The user indicates the dimension hierarchy simply by ordering the dimensions in a desired order. Receiving the user indication of the dimension hierarchy is indicated by block 182 in FIG. 2.

Once the user has selected dimensions 154 and placed them in a hierarchical order on pane 156, the user can provide an input so that product pricing component 104 allows the user to begin setting the pricing based on the selected dimensions 154. In one embodiment, the user simply actuates the “set pricing” button 184 on user interface display 180. Of course, any of a wide variety of different user input mechanisms can be used as well.

In any case, once the user wishes to begin setting the pricing according to the selected dimensions 154, product pricing component 104 generates the multi-dimensional pricing structure 116 according to the dimensions, arranged hierarchically, on pane 156. This is indicated by block 186 in FIG. 2. Product pricing component 104 also illustratively generates another user interface display, such as user interface display 188 shown in FIG. 3C, in order to allow user 112 to begin setting the prices.

FIG. 3C shows that the user is illustratively provided with a currency user input mechanism 190 that allows the user to select a currency that is to be paid for the product or service. In one embodiment, user input mechanism 190 is a dropdown menu that allows the user to select a particular currency from a menu of currencies.

FIG. 3C also shows that the user can provide an effective date in effective date field 192. Field 192 can be set to a current date or a future date so that the product pricing being established by the user can come into effect in the future. Similarly, when the user is looking at historical pricing structures that have been used in the past, the user can illustratively sort the stored pricing structures 116 in data store 106 based on effective date. Therefore, the user can easily identify what pricing structures were in effect on a given date. The effective date field 192 also allows user 112 to quickly and easily change pricing or update pricing, by using promotional pricing dimensions, or otherwise.

User interface display 188 also shows that user 112 has indicated that, for each of the selected dimensions 154, a default pricing is to be used. In one embodiment, the user specifically sets the pricing for each dimension to “default” by selecting it from a menu, typing it into a field adjacent an associated dimension or otherwise. In another embodiment, when product pricing component 104 generates the multi-dimensional pricing structure 116 using selected dimensions 154, it automatically sets the pricing structure for each of the dimensions 154 to “default” and then allows the user to change that, if desired. In the user interface display 188 of FIG. 3C, the user has set a price of $100 dollars as the default price, in default field 194. Thus, the user has established a price of $100 for every dimension that is priced using the “default” price indicator. If no other prices are entered by the user, then each dimension encountered by product pricing component 104 will have a price of $100.

Product pricing component 104 thus illustratively generates a data structure such as that shown below in Table 1, in data store 106. It can be seen that, because the user has entered $100 for the default price, Table 1 shows that as of the effective date, a price of $100 will be charged for all of the dimensions that apply in Table 1, and the currency is specified as US Dollars. In one embodiment, Table 1 represents a relational database table that is stored in data store 106. Of course, it will be appreciated that different types of structures can be used, based upon the particular type of data store 106 being employed by system 100, or based on other considerations.

TABLE 1

| | Cate- | Cus- | | | | |
|---|---|---|---|---|---|---|
| Date | gory | tomer | Contract | Project | Currency | Price |
| Jan. 01, 2011 | | | | | USD | $100.00 |

User 112 next decides to set more specific prices based on the selected dimensions 154. User 112 thus provides a dimensional coordinate (as indicated by block 206 in FIG. 2) to product pricing component 104. Component 104 generates a view of the multi-dimensional pricing structure 116, that contains the selected dimensions 154, from the perspective of the dimensional coordinate and displays that view to the user. User 112 can provide the dimensional coordinate in a variety of different ways. For instance, user 112 can indicate which dimensions the user wishes to see on axes that define structure 116. FIG. 3D shows one example where the user has placed the “categories” dimension on the rows display pane 198. Categories C1-C4 thus populate individual rows in display pane 198. The default value is located on the columns display pane 200. The rows and columns define a price matrix in pane 202. Therefore, the pricing in price matrix pane 202 reflects the default price of $100 for each category C1-C4 in the rows pane 198. In one embodiment, the user places the categories on the rows pane 198 simply by dragging it from dimensions pane 204 that contains the selected dimensions 154 and dropping it on rows pane 198. Of course, the user can move a dimension from pane 204 onto rows pane 198 using other user input mechanisms as well.

The user can identify the dimensional coordinate in a variety of other ways as well. As shown with respect to FIG. 3D, this can be done by placing a dimension on rows pane 198, as indicated by block 208 in FIG. 2. Also, as discussed below, this can be done by the user placing one of the dimensions on columns pane 200. This is indicated by block 210 in FIG. 2. Identifying a specific dimensional coordinate in multi-dimensional pricing structure in other ways is indicated by block 212 in FIG. 2. Displaying the pricing for the dimension placed on rows pane 198 is indicated by block 214 in FIG. 2.

User 112 next desires to override the default pricing for each of the categories in rows pane 198. In one embodiment, each of the prices in pricing pane 202 correspond to a selectable cell so that the user can select each of those prices and input a different price, as desired. FIG. 3E shows another user interface display 216 after the user has modified the prices for various categories C1-C4. It can be seen in FIG. 3E that the user has selected a cell corresponding to the price of category C2 and entered a price of $150. The user has also selected cells corresponding to the prices of categories C3 and C4 and entered prices of $200 and $125, respectively. Therefore, the user has effectively overridden the default pricing for categories C2-C4. However, since the user has not entered a new price for category C1, category C1 is still priced at the default price of $100. Receiving the default override prices for categories C2-C4 is indicated by block 218 in FIG. 2.

Once the user has modified the prices as shown in FIG. 3E, product pricing component 104 illustratively modifies the table stored in data store 106 corresponding to this multi-dimensional pricing structure 116. In one embodiment, the table is modified as shown below in Table 2. Table 2 shows that, for all of categories C2-C4, new prices have been entered, but for any other category, the default price of $100 still applies.

TABLE 2

| | Cate- | Cus- | | | | |
|---|---|---|---|---|---|---|
| Date | gory | tomer | Contract | Project | Currency | Price |
| Jan. 01, 2011 | | | | | USD | $100.00 |
| Jan. 01, 2011 | C2 | | | | USD | $150.00 |
| Jan. 01, 2011 | C3 | | | | USD | $200.00 |
| Jan. 01, 2011 | C4 | | | | USD | $125.00 |

FIG. 3F shows another user interface display 220 which illustrates another way which the user can specify dimensional coordinates for various dimensions 154. In the embodiment shown in user interface display 220, the user has maintained the categories dimension on the rows pane 198 which specifies the rows in pricing grid 202. However, the user has now modified the value corresponding to the project dimension in pane 204 to specify a project P1, as indicated generally at 222 in FIG. 3F. The user has also selected the cell corresponding to the pricing for category C3. Therefore, the cell now corresponds to the specific pricing for category C3 on project P1 only. It can also be seen that the user has entered a new price of $250. Therefore, for all other projects, the pricing for category C3 will still be $200. However, for the specific project P1, the pricing for category C3 will be $250. In one embodiment, the user can select project P1 in a number of different ways. For instance, if the user right clicks on the “project” dimension in pane 204, product pricing component 104 can generate a dropdown menu of the existing projects which can be selected. A wide variety of other ways for selecting a specific project (or other dimension value) can be used as well.

Table 3 below shows how the table in data store 106 can be modified to reflect the override price of $250 for category C3 on project P1. It can be seen that the last line in Table 3 includes a combination of category C3 and project P1 and specifies a price of $250 for that combination of dimensions. However, two lines above shows that for all other dimensions in combination with C3, the price is $200.

TABLE 3

| | Cate- | Cus- | | | | |
|---|---|---|---|---|---|---|
| Date | gory | tomer | Contract | Project | Currency | Price |
| Jan. 01, 2011 | | | | | USD | $100.00 |
| Jan. 01, 2011 | C2 | | | | USD | $150.00 |
| Jan. 01, 2011 | C3 | | | | USD | $200.00 |
| Jan. 01, 2011 | C4 | | | | USD | $125.00 |
| Jan. 01, 2011 | C3 | | | P1 | USD | $250.00 |

FIG. 3G shows yet another user interface display 224 that illustrates a different dimensional coordinate specified by user 112. In the user interface display 224 shown in FIG. 3G, the user has placed the projects dimension on the rows pane 198 so that each row in pricing grid 202 corresponds to a different project P1-P4. FIG. 3G also shows that the user has selected the cell corresponding to project P2 and changed the price from the default value of $100 to $200. Therefore, the price for all combinations of dimensions in project P2 is $200. Because the user 112 has placed the projects dimension on the rows in pane 198, the projects P1-P4 replace the categories C1-C4 as the rows in the multi-dimensional pricing structure 116 represented by user interface display 224.

Table 4 below shows one embodiment in which the table in data store 106 is modified by project pricing component 104 to reflect the change made for project P2. It can be seen that the last row in Table 4 now shows that for project P2, in combination with any other set of dimensions, the price is $200.

TABLE 4

| | Cate- | Cus- | | | | |
|---|---|---|---|---|---|---|
| Date | gory | tomer | Contract | Project | Currency | Price |
| Jan. 01, 2011 | | | | | USD | $100.00 |
| Jan. 01, 2011 | C2 | | | | USD | $150.00 |
| Jan. 01, 2011 | C3 | | | | USD | $200.00 |
| Jan. 01, 2011 | C4 | | | | USD | $125.00 |
| Jan. 01, 2011 | C3 | | | P1 | USD | $250.00 |
| Jan. 01, 2011 | | | | P2 | USD | $200.00 |

FIG. 3H shows yet another user interface display 230 in which the user 112 has decided to take a different view of the multi-dimensional pricing structure 116 (i.e., specifying a different dimensional coordinate from which to view structure 116) by not only placing the projects dimension on the rows of the structure but by also placing the categories C1-C4 on the columns 200 and viewing the combination of projects and categories. Thus, the pricing gird 202 shows the pricing for a combination of projects P1-P4 and categories C1-C4. As shown in Table 4, the prices for all combinations of projects P1-P4 and C1-C4 are shown in pricing grid 202. However, FIG. 3H shows that the user has selected the cell corresponding to the combination of project P4 and category C1 and modified the price to $190. Table 5 below shows how project pricing component 104 modifies the table in data store 106 to reflect the change to the combination of project P4 and category C1. The last row in Table 5 shows that for a combination of category C1 and project P4, the price is set at $190. In one embodiment, a more specific value overrides a less specific value. Therefore, as shown in Table 5, the combination of category C3 and P1 overrides the values specified for just category C3, because the combination of category C3 and project P1 is more specific than simply the category C3. Thus, for the combination of C3 and P1, the price is $250 instead of just $200.

TABLE 5

| | Cate- | Cus- | | | | |
|---|---|---|---|---|---|---|
| Date | gory | tomer | Contract | Project | Currency | Price |
| Jan. 01, 2011 | | | | | USD | $100.00 |
| Jan. 01, 2011 | C1 | | | | USD | $100.00 |
| Jan. 01, 2011 | C2 | | | | USD | $150.00 |
| Jan. 01, 2011 | C3 | | | | USD | $200.00 |
| Jan. 01, 2011 | C4 | | | | USD | $125.00 |
| Jan. 01, 2011 | C3 | | | P1 | USD | $250.00 |
| Jan. 01, 2011 | | | | P2 | USD | $200.00 |
| Jan. 01, 2011 | C1 | | | P4 | USD | $190.00 |

The same is true for the combination of category C1 and project P4. This combination is more specific than simply the category C1. Therefore, in one embodiment, the more specific value of $190 overrides the less specific value of $100 for simply the category C1.

FIG. 3I shows yet another way in which user 112 can take a different view of the multi-dimensional pricing structure 116 (i.e., provide a different dimensional coordinate from which to view structure 116). FIG. 3I illustrates one example of user interface displays that are generated when dimensions are dependent on one another in the hierarchical structure. It can be seen that the user has placed the projects dimension on the rows pane 198 and maintained the categories on the columns 200. However, it can also be seen that the user has specified a value for the contract dimension as a specific contract K1. This is indicated generally in the user interface display 242 of FIG. 3I.

In the example shown in FIG. 3I, the user may have multiple different contracts K1-K5, or other contracts. However, the user has identified a specific contract K1. Product pricing component 104 thus limits the display to those projects and categories which exist in contract K1. It can thus be seen that only projects P1 and P4 are part of contract K1. Therefore, the pricing grid 202 shows the combination of projects P1, P4 and categories C1-C4 for contract K1.

In the example shown in FIG. 3I, a project is always associated with a single contract. Therefore, when contract K1 was specified by user 112, product pricing component 104 filtered out other projects that do not have contract K1 specified as their contract.

As another example, of dependent dimensions, assume that user 112 is attempting to set pricing based on a region and a customer. Assume that every customer is in a single region. Therefore, if a region dimension (or location dimension) is specified by user 112, then only the customers that are in that specific region will be displayed in the multi-dimensional pricing structure 116 displayed by product pricing component 104. Of course, these are only two types of dependent dimensions, and others can be used as well.

Referring again to FIG. 2, once the user has made all of the desired dimensional coordinate overrides, as determined by block 300, product pricing component 104 stores the multi-dimensional pricing structure 116, as modified by user 112, in data store 106 for later use. This is indicated by block 302.

Then, when user 112 wishes to update prices, user 112 can access the stored multi-dimensional pricing structure 116 and view it in the various views shown in FIGS. 3A-31, or according to other views as specified by user 112. Similarly, if the user is not wishing to set prices going forward, but is instead wishing to see prices that have been charged in the past, and dimensions considered in setting those prices, the user can access the multi-dimensional pricing structure 116 and set a view using the effective date 192 and any combination of dimensions 154. In this way, the user can view historical pricing. Other uses of multi-dimensional pricing structure 116 can be performed as well, and this is indicated by block 304 in FIG. 2.

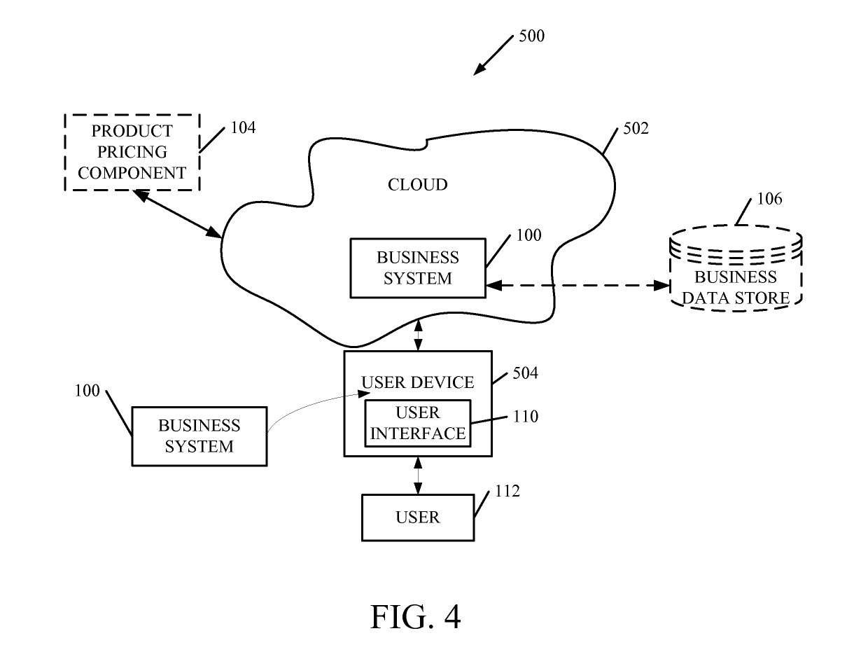

FIG. 4 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that business system 100 is located in cloud 502 (which can be public, private, or a combination where portions are public while others are private). Therefore, user 112 uses a user device 504 to access those systems through cloud 502.

FIG. 4 also depicts another embodiment of a cloud architecture. FIG. 4 shows that it is also contemplated that some elements of business system 100 are disposed in cloud 502 while others are not. By way of example, data store 106 can be disposed outside of cloud 502, and accessed through cloud 502. In another embodiment, product pricing component 104 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. FIG. 4 also shows that system 100, or portions of it, can be disposed on user device 504. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

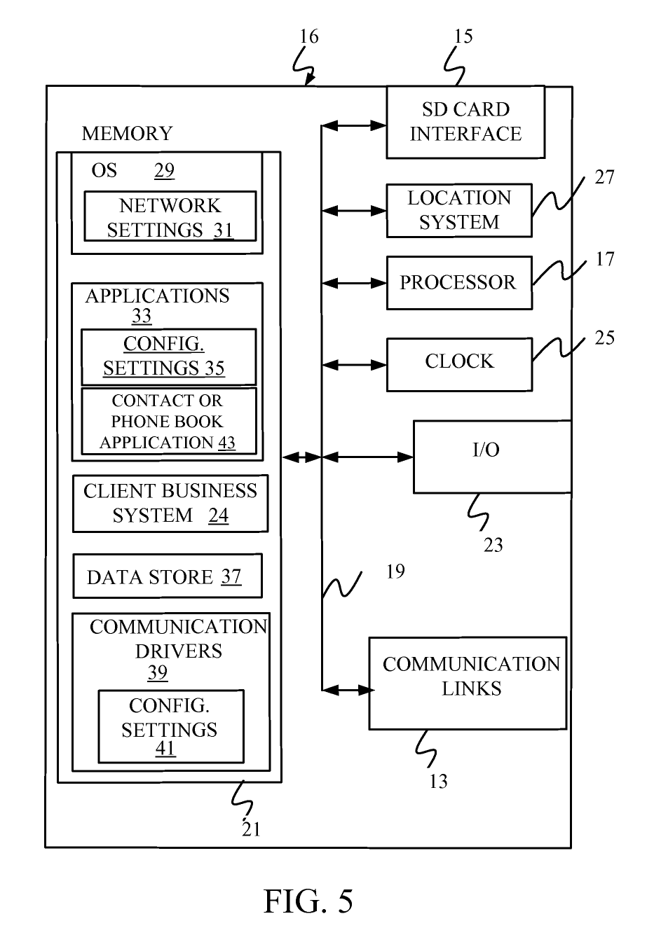

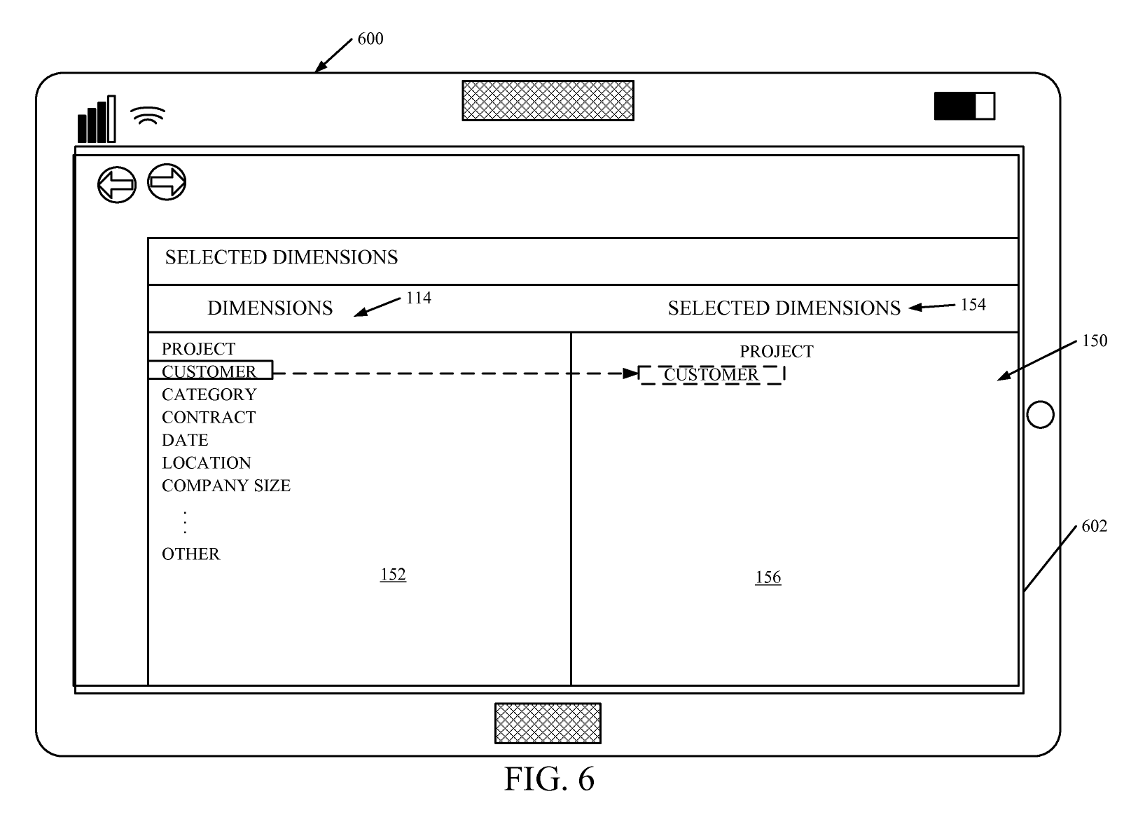

FIG. 5 is a simplified block diagram of one illustrative embodiment of a handheld or mobile computing device that can be used as a user's or client's hand held device 16, in which the present system (or parts of it) can be deployed. FIGS. 6-9 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 102 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 106, for example, can reside in memory 21. Similarly, device 16 can have a client business system 24 which can run various business applications or embody parts or all of business system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

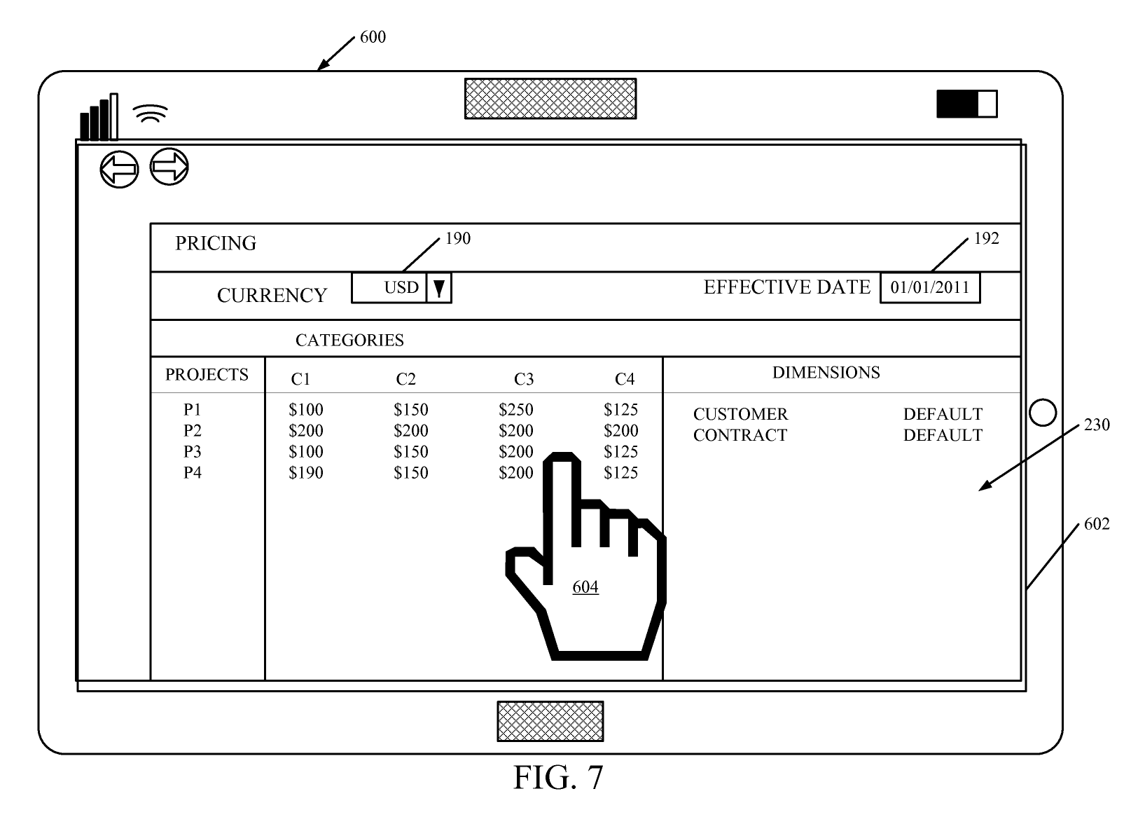

FIGS. 6 and 7 show one embodiment in which device 16 is a tablet computer 600. In FIG. 6, computer 600 is shown with user interface display 150 (used to select dimensions) displayed on the display screen 602. FIG. 7 shows computer 600 with user interface display 230 (used to display a view of multi-dimensional pricing structure from a dimensional coordinate) displayed on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

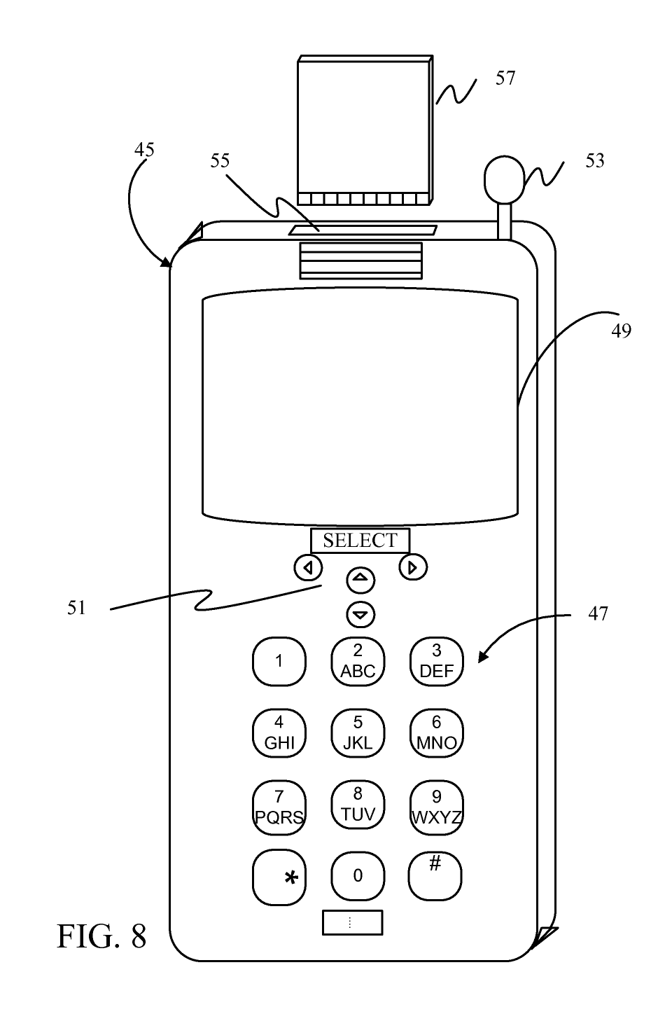

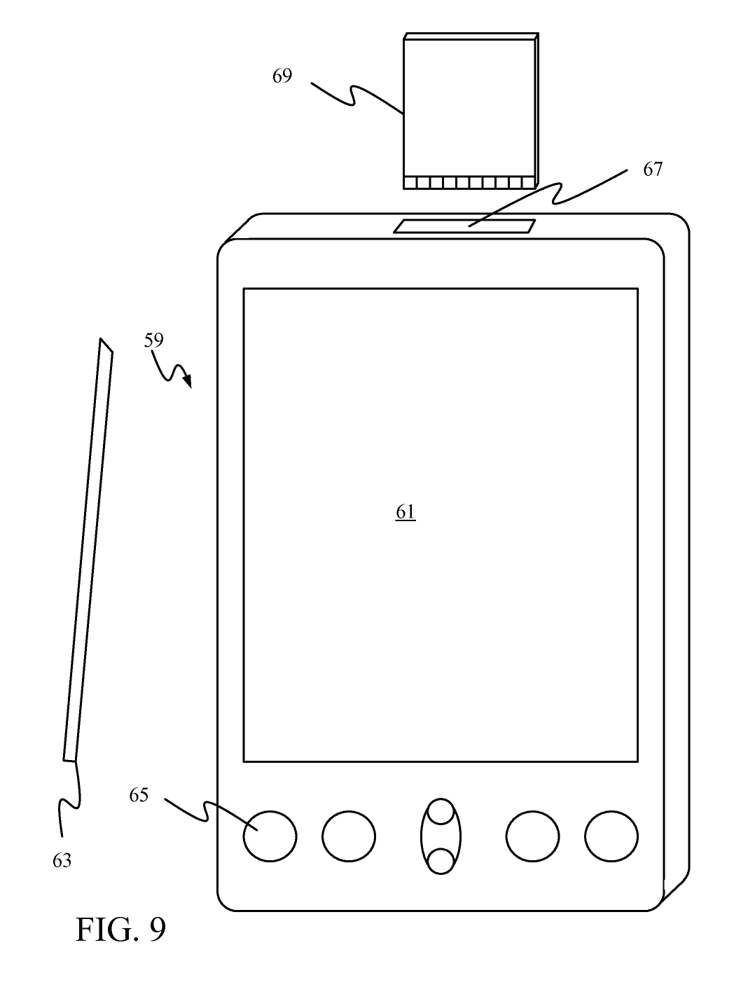

FIGS. 8 and 9 provide additional examples of devices 16 that can be used, although others can be used as well. In FIG. 8, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

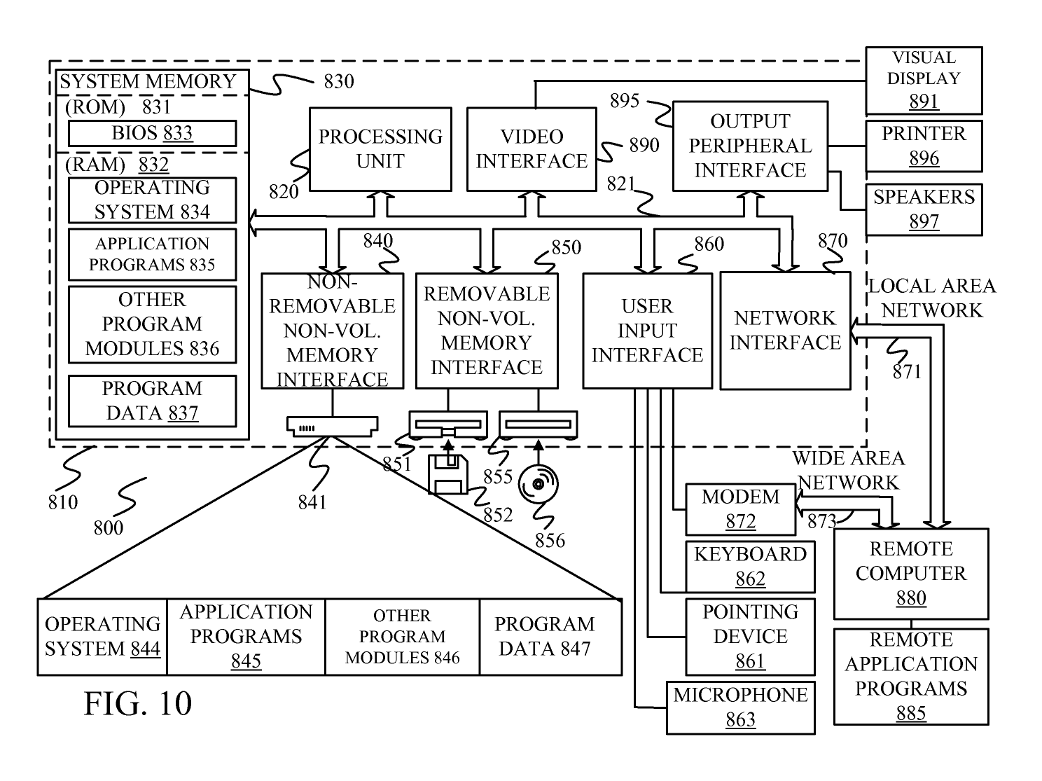

FIG. 10 is one embodiment of a computing environment in which system 100 (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 102), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of generating a multi-dimensional pricing structure, comprising:
generating a dimension selection display with a selection input mechanism that receives a user selection input to select a set of dimensions used in the multi-dimensional pricing structure;
receiving a precedence input that arranges the selected set of dimensions in a precedence hierarchy;
receiving a pricing input that specifies a pricing structure based on the selected dimensions arranged in the precedence hierarchy;
receiving a dimensional coordinate input identifying a dimensional coordinate in the multi-dimensional pricing structure; and
generating a view of the multi-dimensional structure based on the dimensional coordinate, the view displaying the pricing structure that applies based on selected dimensions visible in the multi-dimensional pricing structure from the dimensional coordinate.

2. The computer-implemented method of claim 1 the view of the multi-dimensional pricing structure comprises:
a row display that displays a first dimension along rows in the multi-dimensional pricing structure; and
a column display that displays a second dimension along columns of the multi-dimensional pricing structure, the rows and columns defining a pricing grid of cells, each cell corresponding to an intersection of a row and a column.

3. The computer-implemented method of claim 2 wherein receiving a dimensional coordinate comprises:
receiving a user input identifying the first dimension to be displayed along the rows of the multi-dimensional pricing structure.

4. The computer-implemented method of claim 2 wherein receiving a dimensional coordinate comprises:
receiving a user input identifying the second dimension to be displayed along the columns of the multi-dimensional pricing structure.

5. The computer-implemented method of claim 4 wherein receiving a pricing input comprises:
receiving a default price input indicative of a default price; and
assigning the default price to each cell in the pricing grid.

6. The computer-implemented method of claim 5 wherein receiving a pricing input comprises:
receiving a user price override input specifying a price for a given set of dimensions that overrides the default price for the given set of dimensions.

7. The computer-implemented method of claim 6 wherein receiving a dimensional coordinate further comprises:
receiving a third dimension input identifying a third dimension in the multi-dimensional pricing structure, and wherein generating the view comprises generating the view of the multi-dimensional pricing structure showing the pricing grid for the first and second dimensions and modified to a modified pricing grid based on the third dimensions.

8. The computer-implemented method of claim 7 wherein receiving the third dimension input comprises:
displaying the third dimension along with other selected dimensions, other than the first dimension that is displayed on the row display and the second dimension that is displayed on the column display, in the precedence hierarchy in a selected dimension display portion visually separated from the row display, the column display and the pricing grid; and
receiving the third dimension input as a specific value input adjacent the third dimension in the selected dimension display portion.

9. The computer-implemented method of claim 6 wherein receiving a user price override input comprises:
receiving user selection of at least one cell in the pricing grid; and
receiving the user price override input in the at least one cell in the pricing grid.

10. The computer-implemented method of claim 2 and further comprising:
receiving an effective date dimension input that identifies a date on which the pricing for the multi-dimensional pricing structure takes effect; and
displaying the effective date in the view of the multi-dimensional pricing structure.

11. The computer-implemented method of claim 8 wherein receiving a user input identifying the first dimension to be displayed along the rows of the multi-dimensional pricing structure comprises:
receiving a drag and drop input dragging the first dimension from the selected dimension display portion to a row display portion that displays the rows of the multi-dimensional pricing structure.

12. The computer-implemented method of claim 8 wherein receiving a user input identifying the second dimension to be displayed along the columns of the multi-dimensional pricing structure comprises:
receiving a drag and drop input dragging the second dimension from the selected dimension display portion to a column display portion that displays the columns of the multi-dimensional pricing structure.

13. The computer-implemented method of claim 1 and further comprising:
storing the multi-dimensional pricing structure;
accessing the stored multi-dimensional pricing structure; and
setting a price for a customer based on the multi-dimensional pricing structure.

14. The computer-implemented method of claim 1 and further comprising:
storing the multi-dimensional pricing structure;
accessing the stored multi-dimensional pricing structure by defining an effective date; and
determining what dimensions were considered in setting prices for a customer, in the past, as of the defined effective date.

15. The computer-implemented method of claim 1 wherein the dimensions comprise business dimensions used to establish a price for goods or services, the business dimensions including a set of a plurality of a project, a customer, a category, a contract, a location of the customer, and a company size.

16. A business data system, comprising:
a user interface component generating user interface displays with user input mechanisms that receive user inputs;
a pricing component that accesses a business data store and lists business dimensions used in establishing a price for goods or services and displays them, using the user interface component, in a dimension display, the pricing component receiving dimension selection user inputs selecting a set of selected dimensions from the displayed business dimensions and arranging them in a multi-dimensional pricing structure, the pricing component receiving a coordinate user input defining a coordinate in the multi-dimensional pricing structure and generating a pricing structure display of the multi-dimensional pricing structure from a point of view of the coordinate in the coordinate user input; and
a computer processor, being a functional part of the system and activated by the user interface component and the pricing component to facilitate generating the user interface displays and arranging the set of business dimensions in the multi-dimensional pricing structure.

17. The business data system of claim 16 wherein the pricing component displays the multi-dimensional pricing structure to receive user inputs that define which of the set of selected dimensions are displayed on which axes of the multi-dimensional pricing structure in the pricing structure display.

18. The business data system of claim 17 wherein the pricing component receives user precedence inputs establishing a precedence hierarchy for the set of selected dimensions so when prices corresponding to two or more of the set of dimensions conflict with one another, a price is evaluated according to the precedence hierarchy.

19. The business data system of claim 18 wherein the pricing component includes an effective date as a dimension in multi-dimensional pricing structure and generates the pricing structure display based on a received effective date.

20. A computer readable storage medium storing computer readable instructions which, when executed by a computer, cause the computer to perform a method, comprising:
generating a dimension selection display with a selection input mechanism that receives a user selection input to select a set of dimensions used in the multi-dimensional pricing structure;
receiving a precedence input that arranges the selected set of dimensions in a precedence hierarchy;
receiving a pricing input that specifies a pricing structure based on the selected dimensions arranged in the precedence hierarchy;
receiving a dimensional coordinate input identifying a dimensional coordinate in the multi-dimensional pricing structure; and
generating a view of the multi-dimensional structure based on the dimensional coordinate, the view displaying the pricing structure that applies based on selected dimensions visible in the multi-dimensional pricing structure from the dimensional coordinate and including a row display that displays a first dimension along rows in the multi-dimensional pricing structure, and a column display that displays a second dimension along columns of the multi-dimensional pricing structure, the rows and columns defining a pricing grid of cells, each cell corresponding to an intersection of a row and a column, the dimensional coordinate defining which of the set of selected dimensions is the first dimension displayed on the rows and which of the set of selected dimensions is the second dimension displayed on the columns, wherein receiving a pricing input comprises receiving a user price override input specifying a price for a given set of dimensions that overrides a default price for the given set of dimensions.
